(19) United States
(12) Patent Application Publication
(10) Pub. No.: US 2009/0024405 A1
(43) Pub. Date: Jan. 22, 2009

(54) SYSTEM AND METHOD FOR CONTROLLING THE GENERATION AND DISTRIBUTION OF PUBLICATIONS

(75) Inventors: Roland Brandes, Eggenwil (CH); Jan Lassig, Aarau (CH)

Correspondence Address: PAUL, HASTINGS, JANOFSKY & WALKER LLP, 875 15th Street, NW, Washington, DC, 20005, US

(73) Assignee: UBS AG, Zurich (CH)

(21) Appl. No.: 11/871,631

(22) Filed: Oct. 12, 2007

(30) Foreign Application Priority Data
Jul. 20, 2007 (EP) 07014346.6

(51) Int. Cl. G06Q 10/00

(52) U.S. Cl. 705/1

(57) ABSTRACT

A configurable system and method for controlling the generation and/or distribution of publications, in particular for use by a financial institution, e.g. a bank, comprising the steps of:

(a) providing a plurality of different text elements, and/or graphic elements, and/or table elements (202, 203, 204), or of data representing the respective elements (202, 203, 204), respectively, on one or a plurality of databases (12);

(b) using at least one of said elements (202, 203, 204) or of the data representing said at least one element (202, 203, 204), respectively, for generating a plurality of different, configurable publications.

### SUMMARY OF THE INVENTION

The invention relates to a system and a method for controlling the generation and distribution of publications, in particular for financial institutions, e.g. big banks.

### BACKGROUND OF THE INVENTION

Modern financial institutions, e.g. big banks with, in part, several thousand or several ten thousand or more employees and an agency fund of, in part, several hundred billion or several trillion or more US dollars, etc. generate and distribute a great variety of different publications, e.g. for customers, employees, external investment consultants, etc.

The publications may, for instance, be distributed electronically, e.g. via the Internet, and/or via one or several corresponding intranets, and/or e.g. via appropriate printed media, e.g. brochures, newsletters, and/or via further electronic media such as e-mail and/or SMS, etc.

The individual publications may, for instance, comprise appropriate texts, charts, and/or tables, etc.

Furthermore, the publications are—due to the global presence of big banks which is normal nowadays—frequently published in a variety of different languages and/or local characteristics.

Some publications may be published regularly—e.g. daily (for instance, corresponding financial market reports), monthly (for instance, corresponding newsletters), quarterly, and/or annually (for instance, corresponding company reports), etc.—, others in irregular time intervals.

The generation of a publication may be relatively time-consuming. In particular, first of all the appropriate information has to be collected, edited, and then possibly translated. Furthermore—for reasons of legal certainty—a quality check of the content is, as a rule, carried out, and/or—depending on the respective individual case, and also for reasons of legal certainty—an appropriate disclosure/disclaimer is added manually and/or automatically. Only then can the publication be published and distributed.

If the publications are generated by means of a conventional proceeding, it is—due to the already mentioned possibly high number of different publications and the large number of employees of modern big banks—relatively frequently the case that identical or similar publications (or parts of publications) are generated several times.

This results in an—unnecessary—extra work and consequently in—unnecessary—extra costs.

Moreover, due to the large number of publications and employees it is difficult to ensure that the respective quality standards that are to be guaranteed for reasons of legal certainty are safely kept for all and any of the different publications (e.g. by performing appropriate quality checks), and/or the respective disclosures/disclaimers are worded in a legally correct manner and are added to the respectively published information.

It is an object of the invention to provide a novel system and a novel method for controlling the generation and/or distribution of publications, in particular a novel system and a novel method by which the above-mentioned and/or further disadvantages of prior art can be overcome.

It achieves this and further objects by the subject matters of claims 1 and 12.

Advantageous further developments of the invention are indicated in the sub-claims.

In accordance with one aspect of the invention there is provided a configurative method for controlling the generation and/or distribution of publications, in particular for use by a financial institution, e.g. a bank, the method comprising the steps of:

(a) providing a (configurative) variety of different text elements, and/or graphic elements, and/or table elements, or of data representing the respective elements on one or a plurality of databases;

(b) using at least one of the elements or the data representing the at least one element for generating a plurality of different, configurable publications.

The invention will now be explained in more detail by means of several embodiments and the enclosed drawings.

### BRIEF DESCRIPTION OF THE DRAWINGS

FIG. 1 shows a schematic exemplary representation of a configurative system for controlling the generation and distribution of publications in accordance with an embodiment of the present invention;

FIG. 2 shows a schematic exemplary representation of elements (“components”) or contributions (“contributions”) used in the system illustrated in FIG. 1 for the configurative generation of publications (“publications”);

FIG. 3 shows a schematic exemplary representation for illustrating the elements (“components”) or contributions (“contributions”) used for 1:1 and 1:n publications;

FIG. 4 shows a schematic exemplary representation for illustrating the relation between publications (“publications”), elements (“components”), and contributions (“contributions”); and

FIG. 5 shows a flowchart for illustrating method steps performed in a configurative method for controlling the generation and distribution of publications in accordance with an embodiment of the present invention.

### DETAILED DESCRIPTION OF THE INVENTION

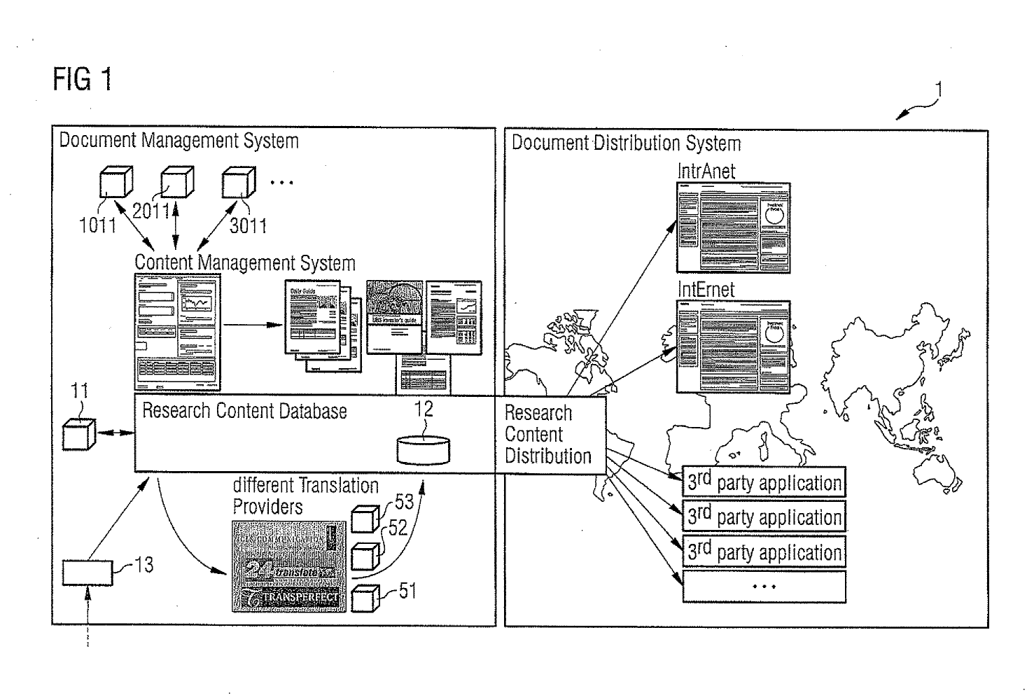

FIG. 1 shows—schematically and by way of example—a system 1 for the configurative controlling of the generation and distribution of publications in accordance with an embodiment of the present invention. The system 1 may, for instance, be used by a financial institution, e.g. a bank, or, for instance, by an insurance company, etc., in particular e.g. by a big bank, for instance, a globally acting big bank with, for instance, more than hundred, thousand, ten thousand, or hundred thousand employees (or more), and/or e.g. more than ten thousand, hundred thousand, one million, ten million (or more) customers, etc.

The configurative generation and distribution of publications is controlled by a central computer 11 (or—in a distributed manner—by a plurality of cooperating central computers) or—more exactly—by one or a plurality of control program(s) executed on the computer(s) and stored on an appropriate computer-readable storage medium.

By means of the system 1, the financial institution using the system 1 can—as will be explained in more detail in the following—, in a simple configurative manner and nevertheless with high quality, generate and distribute a great variety of different publications (e.g. more than ten, hundred, or thousand, ten thousand, etc. different publications), in particular financial publications, e.g. for customers, employees, external investment consultants or asset managers, analysts, etc.

All and any publications are—as will be explained in more detail in the following—stored on one single central database 12 that is adapted to be read and written by the central computer(s) 11 (or on a plurality of distributed, cooperating databases), and are—as will also be explained in more detail in the following—generated and distributed by using this/these central database/databases 12, and controlled by the central computer(s) 11 (or the control program(s) executed on the computer(s) 11, respectively).

The above-mentioned system 1 is part of a company computer network operated or used by the respective financial institution, e.g. the big bank, which may comprise, in addition to the central computer(s) 11 and the database(s) 12, etc. a plurality of further computers, e.g. a plurality of single-user and/or workstation computers 1011, 2011, 3011, etc., etc. that are connected with the computer 11 or the database 12, respectively.

The storing of the publications on the database(s) 12 may, for instance, be performed in a respectively uniform, predetermined format, e.g. in the pdf-format, etc., and with a publication name that distinctly characterizes the respective publication (or a code characterizing same).

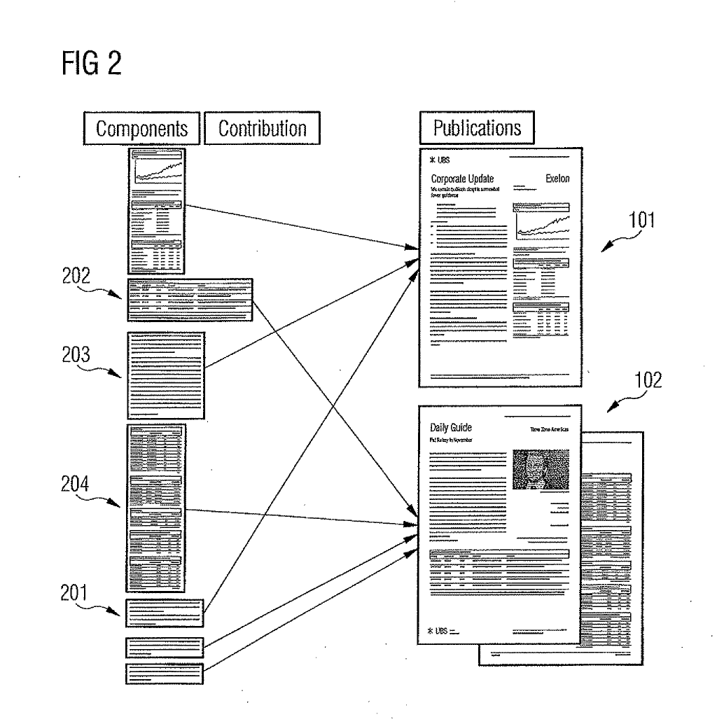

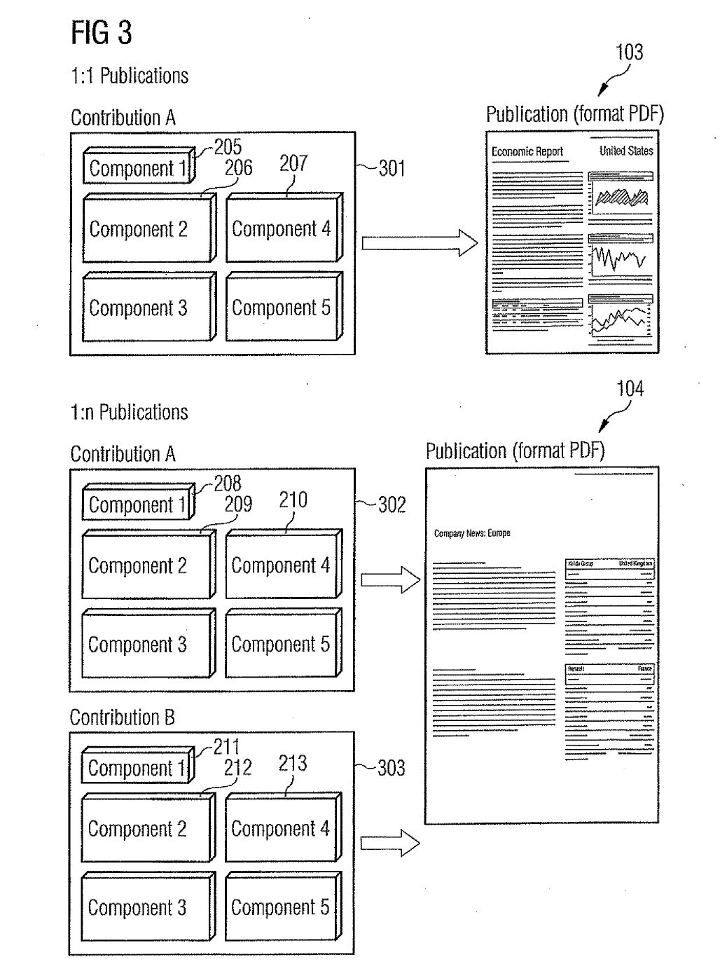

The individual publications 101, 102, 103, 104, 105 (“publications”) may—as is, for instance, illustrated in FIG. 2 and FIG. 3—consist or be composed of one or a plurality of configurative individual elements (“components”) 201, 202, 203, 204, 205, 206, 207, 208, 209, 210, 211, 212, 213, 214, wherein appropriate text elements, and/or graphic elements (e.g. chart elements), and/or table elements, etc. may be used as configurative individual elements.

All and any configurative individual elements (“components”) 201, 202, 203, 204, 205, 206, 207, 208, 209, 210, 211, 212, 213, 214 may—separately from the publications—be stored on the above-mentioned central database(s) 12, e.g. all and any individual elements in a uniform, predetermined format (or all and any individual elements that are assigned to one and the same type of individual elements in a uniform format predetermined for the respective element type).

The method for the configurative generation and distribution of publications or of corresponding documents that can be performed by means of the system 1 is—as is illustrated in FIG. 2 and FIG. 3—based on a plurality of different configurative so-called “contributions” 301, 302, 303, 304, wherein each “contribution” configuratively consists or is composed of one or several of the above-mentioned individual elements (“components”) 201, 202, 203, 204, 205, 206, 207, 208, 209, 210, 211, 212, 213, 214, etc.

An individual “contribution” is composed of respectively configuratively predetermined individual elements (“components”) and is assigned to a respective contribution name that is configuratively predetermined and distinctly characterizes the respective contribution, e.g. a first contribution to the name “DailyGuide”, a second, different contribution to the name “Equity News”, etc., etc.

As results from FIG. 3, an individual publication may—optionally and/or configuratively—be composed of one single contribution, and be published (cf. the publication 103 generated by merely using the contribution 301, as illustrated in FIG. 3 at the top)—so-called 1:1 publication, or optionally alternatively also of several, e.g. two or more contributions (cf. the publication 104 generated by using the contributions 302, 303 and published correspondingly, as illustrated in FIG. 3 at the bottom—so-called 1:n publication.

All and any “contributions” 301, 302, 303, 304 may—separately from the publications, and, for instance, with the respective contribution name or a code characterizing same—be stored on the above-mentioned central database(s) 12, e.g. all and any contributions or contributions assigned to a particular contribution type in a uniform, predetermined format.

The contributions and/or publications (and/or individual elements) are stored on the database(s) 12 by assignment to a reference data set that is configuratively predefined correspondingly, for instance, for the respective contribution or the respective publication.

For storing the data contained in the respective reference data set a uniform, predetermined format may be used for all and any contributions and/or publications (and/or elements).

The respective reference data set may, for instance, include (without being restricted to) the following configurative indications or reference data for the respective contribution/the respective publication/the respective element:
indications or reference data with regard to the respectively concerned currency/currencies (CHF, and/or EUR, and/or USD, and/or JPY, and/or GBP, etc.); and/or
indications or reference data with regard to the respectively concerned currency pair/currency pairs (CHF-EUR, and/or CHF-USD), and/or USD-EUR, and/or USD-GBP, etc.); and/or
indications or reference data with regard to the respectively concerned region/regions (Europe, and/or North America, and/or Asia/Pacific, etc.); and/or
indications or reference data with regard to the respectively concerned country/countries (Switzerland, and/or Germany, and/or USA, etc.); and/or
indications or reference data with regard to the respectively concerned sector (energy, chemistry, information technology, health care, etc.); and/or
indications or reference data with regard to the respectively concerned resource (oil, gold, aluminum, etc.); and/or
indications or reference data with regard to the respectively concerned asset class (equity, real estate, credit, forex, emerging markets, funds, etc.); and/or
indications or reference data with regard to the respectively concerned enterprise (ABB, UBS, Microsoft, etc.); and/or
indications or reference data with regard to the respectively concerned economic indicator (gross national product, business climate, etc.), etc.

As reference data, a code that distinctly defines the respective indication to be taken and that is to be stored in a respectively predetermined place within the respective reference data set may be used.

For any type of contribution/for any type of publication, a particular reference data set to be used may respectively be predetermined configuratively, which, for instance, has to comprise a predetermined (minimum) number of indications or reference data (i.e. particular minimum indications may be mandatory depending on the type of contribution or publication, and have to be stored by assignment to the respective contribution/publication in the above-mentioned database 12).

In addition to these configuratively predetermined (minimum) indications, the respective user of the system 1 may, by assignment to the respective contribution/publication, store—if required—one or several further indications or reference data, i.e. the reference data set that is configuratively predetermined for the respective contribution/publication may be enlarged correspondingly by the respective user if required.

Alternatively or additionally, particular subsets of the above-mentioned reference data or indications or of corresponding further reference data or indications may correspondingly be “blocked” for one or several types of contributions/publications, for instance, since they would not make any sense for the corresponding type of contribution or publication.

The above-mentioned reference data that are stored by assignment to a respective contribution/publication may, for instance, be used as filter criteria for data base queries carried out by using the above-mentioned database(s) 12.

A particular “contribution” (and/or an individual element or component) may be used in an identical form simultaneously or at different times (e.g. on different days, in different weeks, months, quarters) for generating a plurality of different publications (e.g. the contribution 301 illustrated in FIG. 3 in addition to the generation and publication of the publication 103 illustrated in FIG. 3 for the generation of one or a plurality of further publications differing therefrom (or for the generation of one or a plurality of publications with another publication name than the publication 103)).

Alternatively or additionally, a particular contribution and/or a particular individual element may be published several times in one and the same publication (or a publication of a particular name) at respectively different times, e.g. in different local characteristics, e.g. in a respectively identical form, and/or in a form that has been slightly modified/supplemented only (cf. below).

By this possibility of the—complete or at least partial—“re-use” of contributions or elements, unnecessary extra work (and consequently—unnecessary—extra costs) can be avoided (and/or—as a technical effect—storage space may be saved on the database(s) 12).

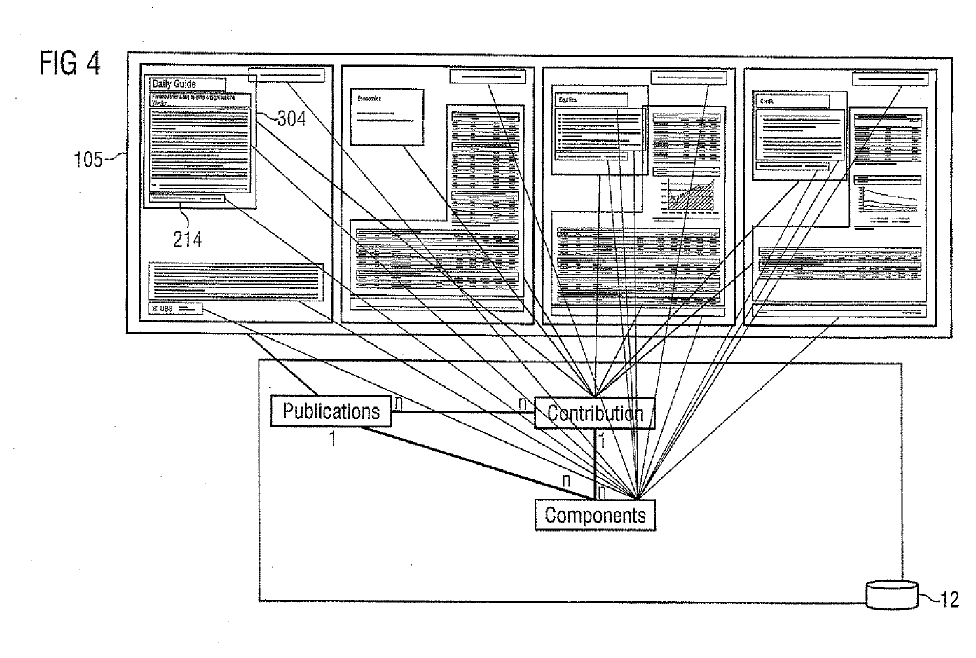

The relation between contributions (and/or individual elements or components) and publications may—as is, for instance, also illustrated in FIG. 4—be defined by means of data that are stored on the database(s) 12 (e.g. corresponding further reference data of the above-mentioned reference data sets), which indicate which contribution or which contributions (and/or individual elements or components) is/are to be published in which publication (and/or in which place in the respective publication, and/or at which time/times or date/data the respective publication is to be published, etc.).

These data can be configured by a user of the system 1 who has an appropriate authorization profile, i.e. can be modified, supplemented, and deleted in advance and/or ex post.

Furthermore—alternatively or additionally—, by means of further data stored on the database(s) 12 (e.g. corresponding farther reference data of the above-mentioned reference data sets), it may be defined or predetermined for one or several of the above-mentioned types of contribution on how many individual elements or components, or on which individual elements or components exactly the respective contribution is based (or on how many or which text elements, and/or graphic elements, and/or table elements, etc.), and/or in which place in the respective contribution the respective element is to be positioned, and/or how large it is to be, etc.

Alternatively or additionally, it is possible to determine, by means of data stored on the database(s) 12 (e.g. corresponding further reference data of the above-mentioned reference data sets), when a particular contribution (and/or a particular individual element or component (and/or a particular publication)) was produced (“production date”), and/or modified (“modification date”), and/or released (“release date”), and/or published (“publication date”).

In order to generate/modify a contribution or individual element or a publication, the respective user of the system 1 may first of all recall a suitable “predecessor” contribution or a suitable “predecessor” element or a suitable “predecessor” publication—i.e. a contribution that has already been stored on the database(s) 12/an individual element that has already been stored on the database(s) 12, etc.

For determining the respective or a respectively suited “predecessor” contribution or “Predecessor” element/“predecessor” publication, the respective user of the system 1—e.g. a respectively authorized employee of the bank from his/her respective single-user or workstation computer 1011, 2011, 3011—may perform a corresponding database enquiry at the database(s) 12, e.g. by using one or several of the above-mentioned reference data stored by assignment to a respective contribution/publication/element, and/or the respective contribution/publication/or element name.

The respectively determined “predecessor” contribution or the respectively determined “predecessor” element or the respectively determined “predecessor” publication may then be used in a simple manner to generate/modify a contribution or individual element or publication in that the text(s), and/or graphic(s), and/or table(s) (or the respective text, and/or graphic, and/or table element(s)) stored for the “predecessor” contribution or the “predecessor” element or the “predecessor” publication are first of all also used for the “successor” contribution or the “successor” element or the “successor” publication and are—possibly after a modification—stored in the database 12, and/or in that the reference data stored for the “predecessor” contribution or the “predecessor” element or the “predecessor” publication are first of all also used for the “successor” contribution or the “successor” element or the “successor” publication and are—possibly after a modification stored in the database 12.

It is also possible to newly assemble a new publication in a simple manner “ad hoc” from contributions/elements that have already been stored in the database 12 (wherein correspondingly suited contributions/elements that have already been stored may be determined as described above, for instance, by using one or several of the above-mentioned reference data stored by assignment to a respective contribution/element, etc.).

In part of the above-mentioned contributions/individual elements, the information used for a respective contribution/a respective individual element are not fed “manually” into the database(s) 12 by a respectively authorized user of the system 1 (e.g. from one of the above-mentioned single-user or workstation computers 1011, 2011, 3011), but the reading and/or updating of the information takes place automatically, e.g. by using a corresponding external interface (here: a market data interface 13).

The market data interface 13 serves to—automatically—recall, in regular time intervals, e.g. daily, corresponding data provided by an external provider from an external computer (e.g. data such as exchange rates, and/or indices, and/or prices for securities, etc.). Alternatively, the corresponding data may also be sent—regularly, e.g. daily—from the respective external provider or its external computer to the market data interface 13 and then be stored there.

The data recalled from or sent to the market data interface 13 or the information contained therein, respectively, are—e.g. controlled by the above-mentioned control program executed on the computer 11—read in the corresponding contributions/individual elements stored on the database 12, or the corresponding information that has already been stored there is correspondingly updated in accordance with the information contained in the market data interface 13.

The feeding/updating may—again—be performed under control of or by means of the above-mentioned reference data sets by which it may be indicated which information supplied by the market data interface 13 its to be fed into which contribution/into which individual element.

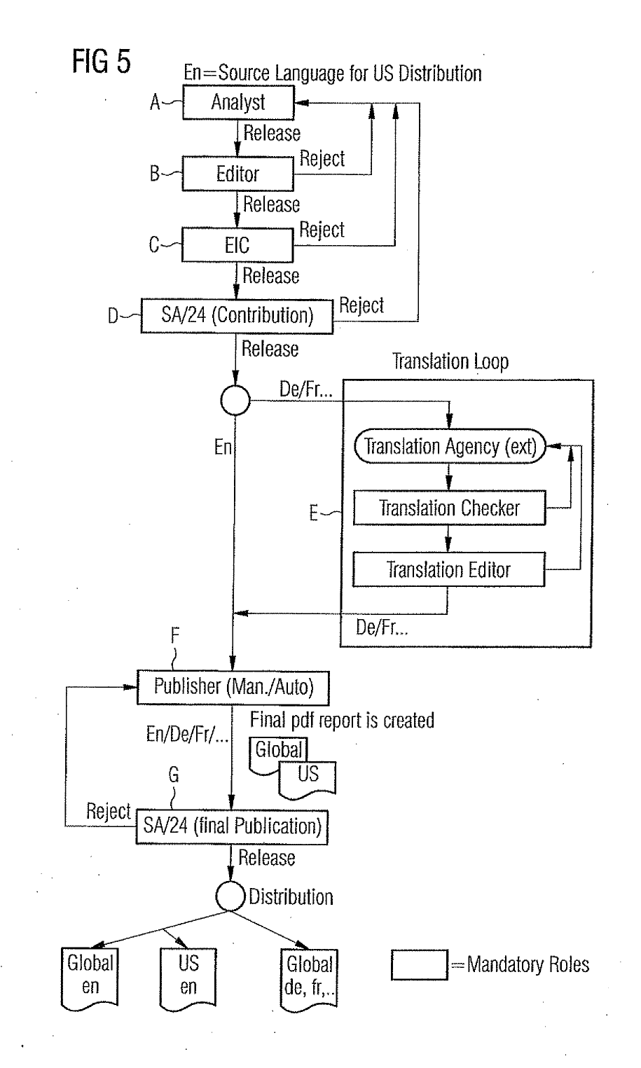

As is shown by way of example in FIG. 5, the generation of a respective contribution/individual element/publication is performed by using respectively predetermined and configurable work flows, wherein the observance of the respective work flow by the system 1—or by the above-mentioned control program executed on the computer 11, respectively—is correspondingly “forced”. This ensures that certain (minimum) quality standards are observed during the generation of contributions/individual elements/publications.

For different types of contributions/individual elements/publications, different configurable work flows (with more or less, and/or other method steps than illustrated by way of example in FIG. 5) may be used.

The work flows to be used for the respective types of contributions/individual elements/publications may be configured correspondingly by a user of the system 1 who has a corresponding authorization profile—e.g. by a respectively authorized employee of the bank from his/her respective single-user or workstation computer 1011, 2011, 3011—, i.e. be modified and/or supplemented in correspondence with the respective demands.

As results from FIG. 5, several different, configurable users of the system 1 participate, as a rule, in the generation of a contribution 1 individual element/publication and have each different functions (“analyst”/“product manager”/“economist”, and/or “editor”, and/or “editor in chief” (“EIC”), and/or “SA/24”, and/or “publisher”, and/or “translation checker”, and/or “translation editor”, etc.), and have each different authorization profiles assigned to the respective functions within the system 1.

A user of the system 1 who assumes the function of the “analyst”/“product manager”/“economist”, etc. has the function of an author in the system 1, i.e. he/she generates—e.g. in the above-mentioned manner—a corresponding (new) contribution/individual element/publication on the database 12, possibly—as explained above—by modifying already existing contributions/individual elements/publications (e.g. from a single-user or workstation computer 1011, 2011, 3011 assigned to the respective user of the system 1)—cf. step A illustrated in FIG. 5.

The respective “analyst”/“product manager”/“economist”, etc. can only generate/modify a respective contribution/individual element/publication if he/she is—defined by data stored on the database 12—authorized to do so.

For instance, a particular “analyst”, etc. may be authorized to generate a contribution/individual element/publication assigned to a first type of contribution/individual element/publication, not, however, to generate a contribution/individual element/publication assigned to a second, different type of contribution/individual element/publication.

However, the respective newly generated or modified contribution/individual element/publication will only be published once the configurative work flow assigned to the respective contribution/individual element/publication has been run through completely.

For instance, as is shown in FIG. 5, the corresponding contribution/individual element/publication generated by the “analyst”/“product manager”/“economist”, etc. has to be correspondingly released by a user of the system 1 who has, for instance, the function of an “editor”—cf step B illustrated in FIG. 5.

The “editor” examines the contribution/individual element/publication supplied in a controlled manner by the system 1 or the above-mentioned control program executed on the computer 11, respectively, with respect to correct grammar, orthography, and level of speech, and, if necessary, carries out the respectively required modifications prior to the release (e.g. from a single-user or workstation computer 1011, 2011, 3011 assigned to the respective user of the system 1) (or refers—in the case of imperfect quality—the contribution/individual element/publication back to the “analyst”/“product manager”/“economist”, etc. who then has to carry out corresponding modifications himself/herself—e.g. from his/her single-user or workstation computer 1011, 2011, 3011—, and, after having carried out the modifications, has to submit the contribution/individual element/publication again to the “editor” for a new check (again controlled by the system 1 or the control program executed on the computer 11, respectively)).

The corresponding contribution/individual element/publication released by the “editor” then has to be correspondingly released by a user of the system 1 who has the function of, for instance, an “EIC”—cf. step C illustrated in FIG. 5.

The “EIC” examines the contribution/individual element/publication supplied in a controlled manner by the system 1 or the above-mentioned control program executed on the computer 11, respectively, e.g. with respect to correctness of the information contained in the contribution/individual element/publication and, if necessary, carries out the respectively required modifications prior to the release (e.g. from a single-user or workstation computer 1011, 2011, 3011 assigned to the respective user of the system 1) (or refers—in the case of imperfect quality—the contribution/individual element/publication back to the “analyst”/“product manager”/“economist”, etc. who then has to carry out corresponding modifications himself/herself—e.g. from his/her single-user or workstation computer 1011, 2011, 3011—, and, after having carried out the modifications, has to submit the contribution/individual element/publication again to the “editor” for a new check (again controlled by the system 1 or the control program executed on the computer 11, respectively)).

The corresponding contribution/individual element/publication released by the “EIC” then has to be correspondingly released by a user of the system 1 who has the function of, for instance, a “SA/24”—cf. step D illustrated in FIG. 5.

The “SA/24” examines—in particular in the case of publications relating to the USA—the contribution/individual element/publication supplied in a controlled manner by the system 1 or the above-mentioned control program executed on the computer 11, respectively, e.g. with respect to legal aspects, for instance, with respect to compliance with the so-called “paragraph/series 24”, with respect to possible negative legal effects of respectively used expressions, etc., and, if necessary, carries out the respectively required modifications prior to the release (e.g. from a single-user or workstation computer 1011, 2011, 3011 assigned to the respective user of the system 1) (or refers—in the case of imperfect quality—the contribution/individual element/publication back to the “analyst”/“product manager”/“economist”, etc. who then has to carry out corresponding modifications himself/herself—e.g. from his/her single-user or workstation computer 1011, 2011, 3011—, and, after having carried out the modifications, has to submit the contribution/individual element/publication again to the “editor” for a new check (again controlled by the system 1 or the control program executed on the computer 11, respectively)).

In the system 1, it is defined for every contribution/individual element/publication or for every type of contribution/individual element/publication, respectively, whether and in which languages the respective contribution/individual element/publication—that is initially generated in English—has to be translated (e.g. by means of corresponding data stored on the database 12, e.g. the above-mentioned reference data, etc.).

If one or a plurality of translations has/have to be done, the corresponding contribution/individual element/publication that has, for instance, been released by the “SA/24” is—automatically and controlled by the system 1 or the above-mentioned control program executed on the computer 11, respectively—supplied to corresponding, external computers 51, 52, 53 (cf. FIG. 1 and step E illustrated in FIG. 5).

The supplying to the external computers 51, 52, 53 may, for instance, be performed by using a corresponding XML data interface.

Depending on the respective language into which the contribution/individual element/publication has to be translated, and/or depending on the respective type of contribution/individual element/publication, the contribution/individual element/publication may be supplied to respectively different external computers 51, 52, 53—i.e. to respectively different translation firms.

The contributions/individual elements/publications supplied to the external computers 51, 52, 53 are then translated into the respectively desired language(s) by appropriate translators of the translation firms.

The respective translations then have—as is illustrated in FIG. 5—to be correspondingly released or, if necessary, be modified (or referred back to the respective translator) by persons who have the function of a “translation checker” or “translation editor”.

The released translations are supplied to the system 1 from the external computers 51, 52, 53, e.g. again by using the corresponding XML data interface, and are fed into the database 12.

The corresponding, translated, released contributions/individual elements/publications that have been fed into the database 12 then have to be correspondingly further processed (cf. below) and released by a user of the system 1 who has the function of a “publisher”—cf. step F illustrated in FIG. 5.

The “publisher” examines the contributions/individual elements/publications supplied in a controlled manner by the system 1 or the above-mentioned control program executed on the computer 11, respectively, and, if necessary, carries out the respectively required modifications, e.g. format adaptations, prior to the release (e.g. from a single-user or workstation computer 1011, 2011, 3011 assigned to the respective user of the system 1).

Alternatively or additionally, the “publisher” may—as explained above—assemble a “1:n publication” from several different contributions/individual elements/publications (cf. also FIG. 3).

Subsequently, the “publisher”—controlled by the system 1, and e.g. from his/her respective single-user or workstation computer 1011, 2011, 3011—generates—from the correspondingly translated, released, and possibly correspondingly assembled and/or modified contributions/individual elements/publications corresponding pdf documents that are intended for publication, e.g. by using an appropriate PDF creator.

The pdf documents are—again—stored in the database 12.

The corresponding pdf documents released by the “publisher” then have to be correspondingly released by a user of the system 1 who has the function of a “SA/24”—cf. step G illustrated in FIG. 5. The “SA/24” may—in the case of imperfect quality—modify the documents correspondingly or refer them back to the “publisher” who then has to carry out corresponding modifications himself/herself—e.g. from his/her single-user or workstation computer 1011, 2011, 3011—, and, after having carried out the modifications, has to submit the documents again to the “SA/24” for a new check (again controlled by the system 1 or the control program executed on the computer 11, respectively)).

In further alternative variants, the system 1—in particular the above-mentioned control program executed on the computer 11—ensures that—if necessary—a corresponding contribution/individual element/publication is published along with an assigned “disclosure” only.

This may, for instance, be achieved in that corresponding, predetermined disclosures are definitely assigned to respective particular types of contributions/individual elements/publications, and are each attached to the corresponding publication (e.g. the respective pdf document) automatically by the system 1.

Which disclosure is to be used with which type of contribution/individual element/publication may be defined by means of corresponding data stored on the database 12, e.g. by means of corresponding reference data of the above-mentioned reference data sets.

The publications generated in the above-mentioned manner and stored on the database 12 (here. e.g. the above-mentioned pdf documents) may—as is illustrated in FIG. 1—for instance, be spread electronically by means of the system 1, e.g. via the Internet, and/or via one or several corresponding intranets, and/or, for instance, via corresponding XML data interfaces to corresponding third applications (i.e. to corresponding external computers).

The third applications serve, for instance, to (further) spread the publications via appropriate printed media, e.g. brochures, newsletters, inserts, etc.

By means of the third applications, the corresponding documents—received via the XML data interfaces—may, for instance, be further processed and printed.

The exact time(s) or the exact date/the exact data at which the respective publication has to be published or to be spread/to be distributed exactly, and/or the respective publication channel to be used (Internet, and/or intranet, and/or third applications, etc.) may, as already explained, be defined by means of corresponding data stored on the database 12, e.g. the above-mentioned reference data of the above-mentioned reference data sets.

The publication or distribution may then—controlled by the system 1, in particular the above-mentioned control program executed on the computer 11—be performed in a fully automated manner at the times defined as explained above, and via the publication channels defined as explained above.

The publications published via a corresponding intranet may, for instance, be correspondingly inspected by employees of the big bank, and the publications published via the Internet, for instance, by customers, external investment consultants or asset managers, etc., for instance, in the form of a great variety of different, e.g. several hundred, configurative websites that can be recalled in several languages (cf below).

Along with or additionally to the actual publications (or, alternatively, separately therefrom), the reference data assigned to a respective publication and stored on the database 12, or subsets thereof, respectively, or data corresponding thereto, may optionally also be recallable.

The employees, customers, external investment consultants or asset managers, etc. may thus also carry out corresponding (publication) database enquiries via the Internet or a corresponding intranet, in which the above-mentioned reference data stored by assignment to a respective publication are used as filter criteria.

Part of the above-mentioned websites may each comprise publications/contributions/individual elements predefined or configured or selected by corresponding system administrators, said publications/contributions/individual elements being displayed in places on the respective website which are defined by the respective system administrator (the websites can thus be configured by the system administrators). The above-mentioned websites may also be configured in a user group-specific manner (i.e. may comprise publications/contributions/individual elements which are selected user group-individually and which are displayed in places on the respective website which are defined by the respective user group).

For configuring and controlling the websites, corresponding navigation definition files which are, for instance, stored on the above-mentioned database 12 and which are adapted to be configured or programmed by a corresponding web front end may be used.

By means of the web front end, a set of generic widgets or of graphic display components of a graphic user surface is—on the basis of the corresponding generic publications/contributions/individual elements stored on the database 12 and released for publication—provided to the respective user groups (by means of which the user may interact via the Internet or the corresponding intranet).

The widget set may, for instance, comprise the following widget types: chart widgets, and/or table widgets, and/or news list widgets, and/or regular documents list widgets, and/or featured documents list widgets, etc., etc.

Based on the widget types and using the above-mentioned web front end, hundreds of different websites may be configured in a user group-specific manner, wherein individual websites may be linked hierarchically in a flexibly configurable manner with other websites (and may comprise corresponding flexibly configurable horizontal and vertical menu structures).

By means of the navigation definition files generated during website configuration and stored on the above-mentioned database 12 it is specified—user group-individually—which publications/contributions/individual elements a respective website is to contain, in which place on the respective website the corresponding publications/contributions/individual elements are to be displayed, and with which other websites and in which way exactly a respective website is to be linked.

Depending on the respective identification with which the user logs into the system 1 later, and/or depending on the identification of the computer with which the user logs in, the respective, user group-specific navigation definition file is then used for the representation of websites, and thus the corresponding website that has been configured in a user group-specific manner is displayed on the respective computer of the user.

Alternatively, the information or contents contained in the website may—if desired by the corresponding user group—be subject to additional filtering that is, for instance, based on the above-mentioned reference data stored by assignment to a respective publication. Corresponding to the desires of the user group and the filter data correspondingly input by the user via the above-mentioned graphic user surface, only those information or contents may then be displayed, for instance, on a respective website which relate, in correspondence with the above-mentioned reference data, e.g. to Switzerland (and/or Germany, and/or the USA, etc.), and/or the sector health care (or energy, or information technology, etc.), etc.

Alternatively or additionally, the users of the system 1 may, via the Internet or a corresponding intranet, perform corresponding full text and/or content searches with respect to the information of the publications/contributions/single elements stored on the database 12, and/or searches based on the reference data stored on the database 12.

What is claimed is:

1. A method for controlling the generation and/or distribution of publications, in particular for use by a financial institution, the method comprising the steps of:
a. providing a plurality of different text elements, and/or graphic elements, and/or table elements (202, 203, 204), or of data representing the respective elements (202, 203, 204), respectively, on one or a plurality of databases (12);
b. using at least one of said elements (202, 203, 204) or of the data representing said at least one element (202, 203, 204), respectively, for generating a plurality of different, configurable publications.

2. The method according to claim 1, further comprising the step of: generating the publications by using configurable data that indicate which elements (202, 203, 204) or groups (301, 302) of elements are to be used for which publication.

3. The method according to claims 1, further comprising the step of: generating the publications by using configurable data which indicate in which place within a respective publication the elements (202, 203, 204) or groups (301, 302) of elements are to be positioned in the respective publication.

4. The method according to claim 1, wherein the generated publications or the configurative data representing the generated publications, respectively, are stored on the database(s) (12).

5. The method according to claim 1, wherein at least one respective reference data set that is also stored on the database(s) 12 is configuratively assigned to the elements or groups of elements or publications.

6. The method according to claim 5, wherein the configurable reference data set may contain data which may comprise indications with regard to the respectively concerned currency, and/or indications with regard to the respectively concerned region, and/or indications with regard to the respectively concerned country, and/or indications with regard to the respectively concerned sector, and/or indications with regard to the respectively concerned resource, and/or indications with regard to the respectively concerned asset class, and/or indications with regard to the respectively concerned enterprise, and/or indications with regard to the respectively concerned economic indicator, and/or one or a plurality of further indications.

7. The method according to claim 1, which additionally comprises the step of: configurative distribution of the generated publications via an electronic medium.

8. The method according to claim 7, wherein the electronic medium is the Internet or an intranet.

9. The method according to claim 1, further comprising the step of: distributing the generated publications via a printed medium.

10. The method according to claim 7, wherein the different publications are distributed via user group-specifically configurable websites.

11. The method according to claim 10, wherein, depending on the respective user group-specific configuration, different publications are displayed on the respective website.

12. A system (1) for controlling the generation and/or distribution of publications, comprising at least one computer (11) and at least one database (12) on which a plurality of different text elements, and/or graphic elements, and/or table elements (202, 203, 204), or data representing the respective elements (202, 203, 204), respectively, are stored, wherein means for generating configurable publications are additionally provided, wherein at least one of said elements (202, 203, 204) or of the data representing said at least one element (202, 203, 204), respectively, is/are used for generating a plurality of different, configurable publications.

13. A computer readable medium comprising computer executable instructions adapted to perform the method of claim 1.

14. A general purpose computer that is programmed to perform the steps of:
(a) providing a plurality of different text elements, and/or graphic elements, and/or table elements (202, 203, 204), or of data representing the respective elements (202, 203, 204), respectively, on one or a plurality of databases (12);
(b) using at least one of said elements (202, 203, 204) or of the data representing said at least one element (202, 203, 204), respectively, for generating a plurality of different, configurable publications.
